(19) United States
(12) Patent Application Publication
(10) Pub. No.: US 2012/0268468 A1
(43) Pub. Date: Oct. 25, 2012

(54) SYSTEM AND METHOD FOR STOCHASTICALLY GENERATING MAPS OF PLACES IN A VIRTUAL SPACE

(75) Inventor: Orion ELENZIL, San Francisco, CA (US)

(73) Assignee: Idle Games, San Francisco, CA (US)

(21) Appl. No.: 13/091,001

(22) Filed: Apr. 20, 2011

(51) Int. Cl. G06T 11/20

(52) U.S. Cl. 345/441

(57) ABSTRACT

Maps of places for implementation in a virtual space may be stochastically generated. The stochastic generation of the maps may result in places within the virtual space seeming unique because of the vast number of arrangements of features that can be achieved. The appearance of uniqueness may be maintained between places even if some or all of the features are common between the places. This may enhance realism of the virtual space, engagement by users, and/or provide other benefits.

### FIELD OF THE INVENTION

The invention relates to a system and method for stochastically generating maps of places within a virtual space that have a set of features and/or items in common for the purposes of a game played within the virtual space.

### BACKGROUND OF THE INVENTION

Systems that provide virtual spaces to users are known. Some of these virtual spaces are composed of individual places that need to have a set of features and/or items in common for a game played within the virtual space. Generally, the layout, or map, of the individual places in these spaces are created manually by administrators or developers, or are selected a finite set of predetermined layouts. This may lead to a lack of variation between different places in a virtual space.

### SUMMARY

One aspect of the invention relates to a system and method for stochastically generating maps of places for implementation in a virtual space. The stochastic generation of the maps may result in places within the virtual space seeming unique because of the vast number of arrangements of features that can be achieved. The appearance of uniqueness may be maintained between places even if some or all of the features are common between the places. This may enhance realism of the virtual space, engagement by users, and/or provide other benefits.

A system that generates maps of places for implementation in a virtual space may be configured to execute computer program modules. The computer program modules may include one or more of an array generation module, a smoothing module, an area module, a feature module, a verification module, a tertiary type module, an items module, a type collapse module, a crop module, a storage module, and/or other modules.

To generate a map of a place for implementation in a virtual space, an array of tiles that form a surface may be stochastically generated. Generating the array of tiles may include stochastically assigning individual tiles in the array of tiles with a primary tile type. The primary tile types assigned to the tiles may include a first type, a second type, and/or other types. A cluster of tiles may be assigned the first primary type such that the shape, size, and/or other parameters of the cluster of first primary type tiles is stochastic. In some implementations, the first type may correspond to land and the second type may correspond to water such that the cluster of first primary type tiles defines an island. Generation of the array of tiles may be performed by the array generation module.

In the array to tiles, the shape of the cluster of first primary type tiles may be smoothed. Smoothing the shape of the cluster may include rounding the corners of the cluster, reducing or eliminating spurs from the shape of the cluster, and/or other smoothing operations. The smoothing may make the shape of the cluster appear more like a real world topographical feature, such as an island, for example. Other shaping operations may be performed. This smoothing may be performed by the smoothing module.

A determination may be made as to whether a suitable area exists in the cluster of first primary type tiles for placement of a feature. The feature may include one or more of a mountain, a volcano, a mine, a patch of dirt, a plain, a forest, a tree, a clearing, a body or water, a building, a building site, an idol, an idol platform, and/or other features. The determination may be based on a set of criteria for a suitable area. Responsive to a determination that no suitable area exists in the cluster, the array of tiles may be discarded. The determination as to whether a suitable area exists may be made by the area module.

Responsive to a determination that a suitable area exists in the cluster of first primary type tiles, a suitable area may be stochastically defined as the feature. Defining the suitable area as the feature may include assigning tiles in the suitable area with a secondary type. The definition may be stochastic, but constrained by the criteria used to determine if a suitable area exists in the cluster. The definition of the suitable area as the feature may be performed by the feature module.

A verification may be performed that the cluster of first primary type tiles in the array of tiles satisfies one or more cluster criteria. The cluster criteria may include a maximum and/or minimum size, a shape, a maximum and/or minimum width, a maximum or minimum length, and/or other criteria. The verification may be performed by the verification module. Responsive to a determination that the cluster does not satisfy the cluster criteria, the array of tiles may be discarded.

Tertiary tile types may be assigned to the tiles in the array of tiles. The assignment of a tertiary type to a given tile may be based on a primary and/or secondary type of the given tile, a primary and/or secondary type of one or more tiles bordering on the given tile, and/or other factors. By way of non-limiting example, in implementations in which the first type corresponds to land and the second type corresponds to land, and in which a feature placed includes a patch of dirt, the tertiary types may include grass, dirt edge, dirt interior, beach, shallow water, intermediate water, open water, and/or other types. The assignment of tertiary tile types may be performed by the tertiary type module.

One or more items may be placed around the array of tiles. An item may include, for example, a tree, a mine, a quarry, a plant, a flower, a non-player character, and/or other items. The placement of the items may be based on item criteria associated with the items. For example, for a given item, the item criteria may specify a tertiary tile type, spatial position with respect to other items or features, spatial position with respect to one or more tertiary tile types, and/or other criteria. The items may be placed by the item module.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a method of generating maps of simulated places.

FIG. 2 illustrates an array of tiles forming a surface of a place.

FIG. 3 illustrates an array of tiles forming a surface of a place.

FIG. 4 illustrates an array of tiles forming a surface of a place.

FIG. 5 illustrates an array of tiles forming a surface of a place.

FIG. 6 illustrates an array of tiles forming a surface of a place.

FIG. 7 illustrates a system configured to generate maps of simulated places.

### DETAILED DESCRIPTION

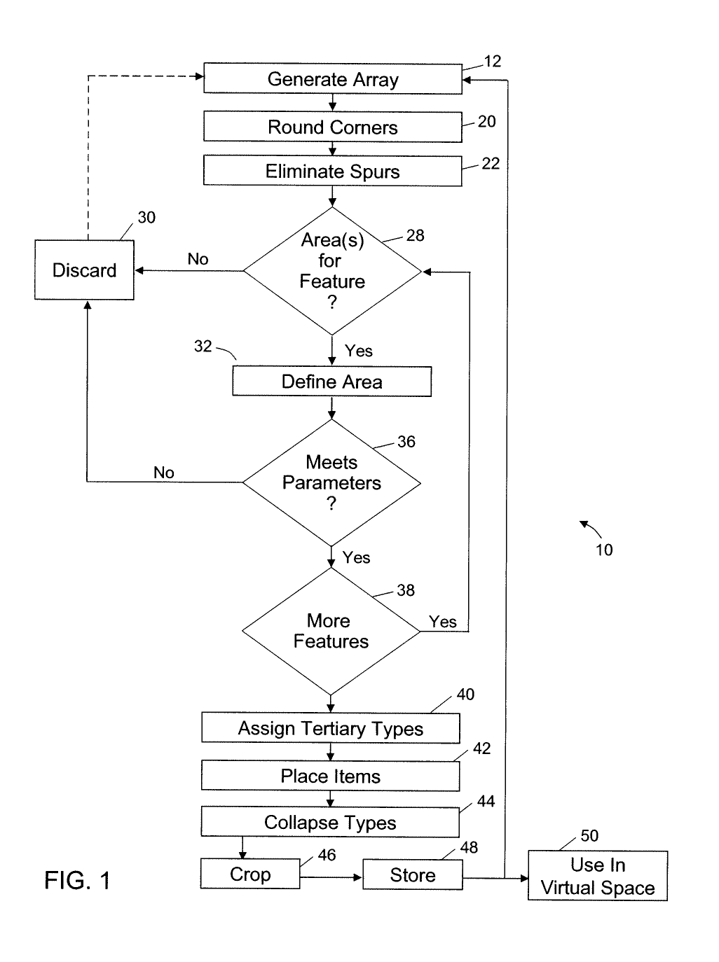

FIG. 1 illustrates a method 10 of generating maps of simulated places. The places may include topographies, building or building complex interiors, underwater spaces, and/or other places. The places depicted in the maps may be used as places in a virtual space (or spaces). The places generated may include a set of features and/or items in common while the arrangement of some or all of these features may be stochastic. The operations of method 10 presented below are intended to be illustrative. In some embodiments, method 10 may be accomplished with one or more additional operations not described, and/or without one or more of the operations discussed. Additionally, the order in which the operations of method 10 are illustrated in FIG. 1 and described below is not intended to be limiting.

In some embodiments, method 10 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 10 in response to instructions stored electronically on an electronic storage medium. The one or more processing devices may include one or more devices configured through hardware, firmware, and/or software to be specifically designed for execution of one or more of the operations of method 10.

At an operation 12, an array of tiles that form a surface may be generated. The tiles may have a common shape, a series of shapes, irregular shapes, and/or other shapes. The boundaries of the tiles may form a polygonal grid across the surface. Generating the array of tiles may include assigning some of the tiles with a first primary type. Other tiles in the array of tiles may be assigned with a second primary type. In some implementations, the tiles may be assigned with a primary type (e.g., first or second) such that one or more clusters of tiles have common type. For example, generating the array of tiles may include assigning a cluster of tiles with the first primary type. As used herein, a “cluster” of tiles may refer to a set of tiles that form a contiguous body of tiles.

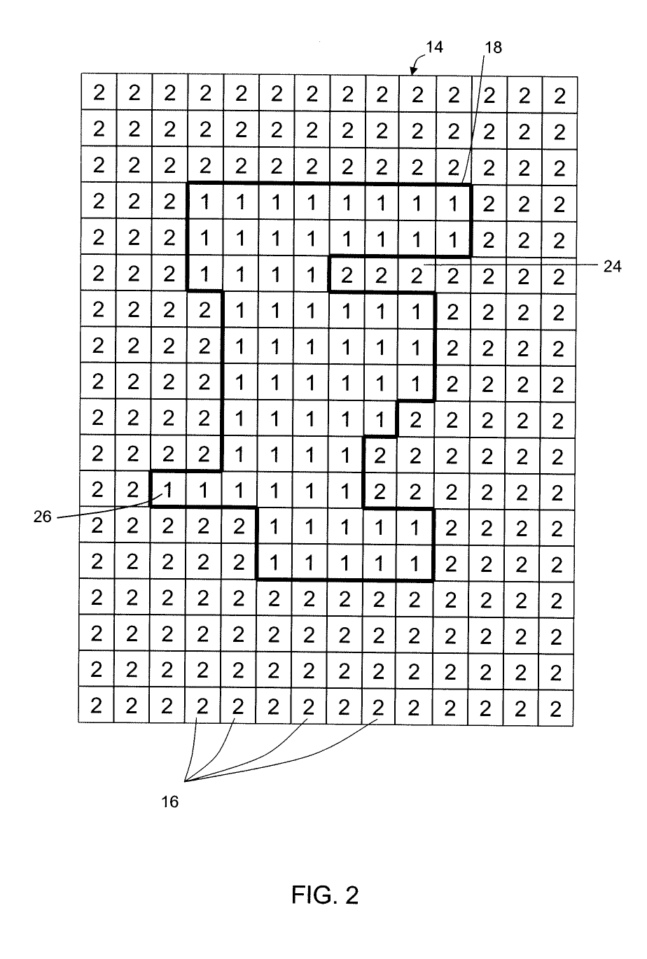

By way of non-limiting illustration, FIG. 2 depicts an array 14 of tiles 16. In FIG. 2, the boundaries of tiles 16 may form a rectangular (even square) grid across the surface of array 14. The array 14 includes tiles 16 that have been assigned with the first primary type (bearing a “1” in FIG. 2), and tiles 16 that have been assigned with the second primary type (bearing a “2” in FIG. 2). The tiles 16 assigned with the first primary type may form a cluster 18. It will be appreciated that the top-down point-of-view in FIG. 2 is not intended to be limiting. The array 14 may be in an isometric space, a 3-dimensional space, and/or other spaces.

Returning to FIG. 1, the first primary type may correspond to land within the place represented by the array of tiles. The second primary type may correspond to water surface at the place. As such, the cluster of tiles assigned with the first primary type may form an island within a set of tiles assigned with the second primary type. It will be appreciated that discussion herein of the creation of maps of islands is not intended to be limiting. The principles described herein, including the assignment of tile types at the generation of the array of tiles, may be adjusted to produce types of places other than islands (e.g., lakes, oceans, landmass that connects to other landmass, buildings, caves, and/or other places).

At operation 12, the array of tiles may be stochastically generated. The stochastic generation may be constrained by one or more array constraints. The array constraints may include, for example, a threshold number of first primary type tiles, a maximum number of first primary type tiles, a minimum number of first primary type tiles, a threshold number of tiles in the cluster of first primary type tiles, a maximum number of tiles in the cluster of first primary type tiles, a minimum number of tiles in the cluster of first primary type tiles, and/or other constraints. Generating the array of tiles stochastically may include stochastically assigning individual tiles in the array of tiles with a primary type (e.g., first, second, and/or other primary types), subject to the array constraints. The stochastic assignment of an individual tiles with a primary type may be random, pseudo-random, and/or other stochastic assignments.

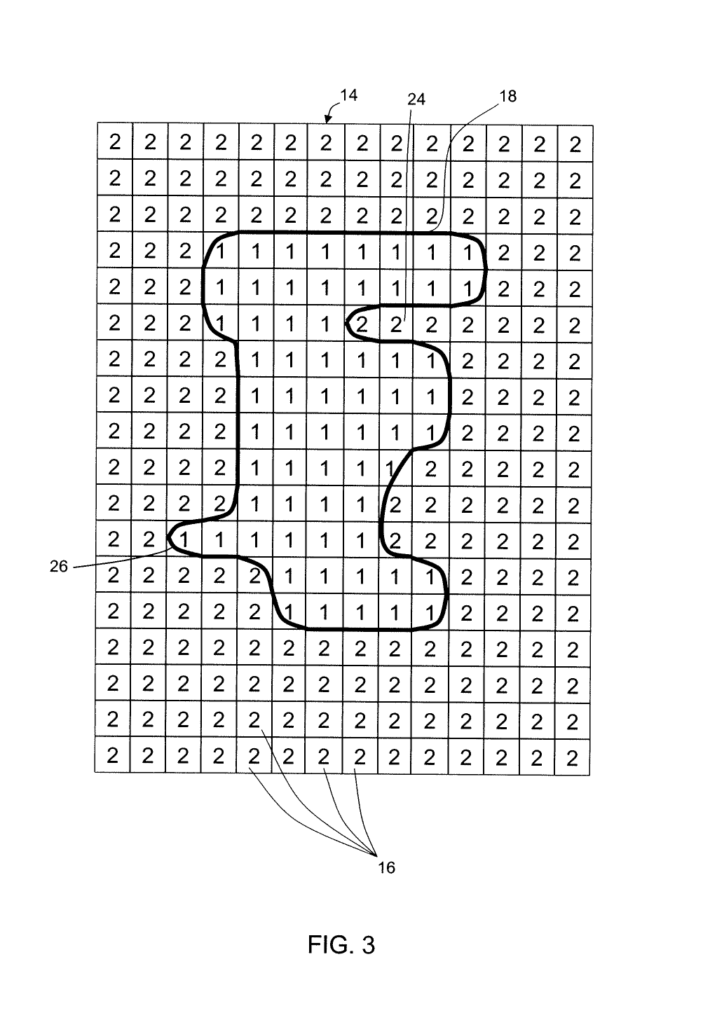

At an operation 20, corners of the area of the place that corresponds to the tiles in the cluster of first primary type types, hereafter referred to as the “first cluster”, may be smoothed. Smoothing the corners of the first cluster may include rounding the corners of the first cluster and/or other smoothing operations performed at the corners. By way of illustration, FIG. 3 depicts cluster 18 in array 14, with the corners of cluster 18 rounded. This may more change the overall shape of cluster 18 to correspond more realistically with the shape of an island, or other place, in the real world.

At an operation 22, spurs of the first cluster may be modified. As used herein, the term “spur” may refer to an extrusion from, or intrusion into, a cluster of tiles having a common type (e.g., the first cluster). A spur may be identified based on having a width that is less than a width threshold (e.g., at is narrowest point, at its thickest point, a mean or median width, and/or other metrics indicating width), a length that is greater than a length threshold, and/or based on other parameters. The width threshold and/or the length threshold may be dynamic (e.g., determined as a function of the size of the cluster, determined as a function of the dimensions of the potential spur, and/or determined as a function of other parameters), determined based on user or administrator input, be predetermined, and/or otherwise determined or obtained.

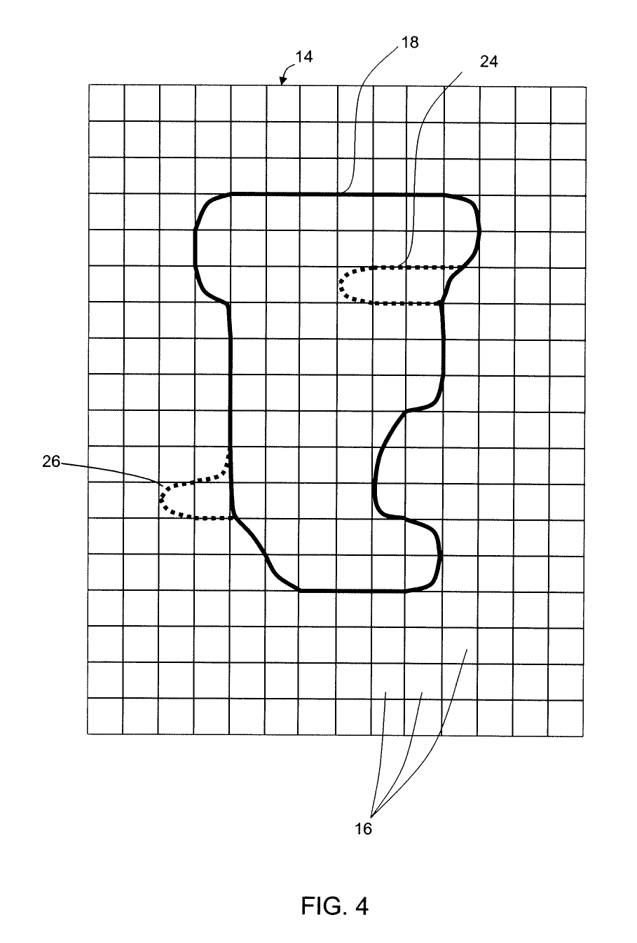

By way of illustration, referring back to FIG. 3, cluster 18 may include an extrusive spur 24 and/or an intrusive spur 26. Modification of spurs 24 and/or 26 may include modifying the assignments of tile types to adjust the dimensions of spurs 24 and/or 26, modifying the assignments of tile types to reduce or eliminate spurs 24 and/or 26, and/or other modifications. For further illustration of this non-limiting example, FIG. 4 depicts array 14 in which assignments of tile type for the tiles of spurs 24 and/or 26 may have been modified to reduce or eliminate spurs 24 and/or 26 (which are shown in dashed line for reference).

Returning to FIG. 1, at an operation 28, a determination may be made as to whether there exists in the first cluster a suitable area for placement of a first feature. The first feature may include a simulated geological or geographical feature (e.g., a mountain, a volcano, a mine, a plain, a forest, a tree, a clearing, a body or water, and/or other geological or geographical feature), a simulated artificial feature (e.g., a building, a building site, an idol, an idol platform, and/or other simulated features which would be man-made in the real world), and/or other features. In some implementations, the first feature may include, for example, a patch of dirt. A suitable area may be an area that meets criteria associated with the first feature. Such criteria may include, for example, a total number of tiles to be included in the area, a shape for the area, a minimum length for the area, a maximum length for the area, a minimum width for the area, a maximum width for the area, a regional constraint that constrains the first feature to some region in the first cluster (e.g., to the north, to the east, to the west, to the south, and/or some combination of these regions, and/or other regions), and/or other criteria.

Responsive to a determination at operation 28 that no suitable area exists in the first cluster, method 10 may proceed to an operation 30. At operation 30 the array of tiles may be discarded. This may include deleting the array of tiles from memory, taking no further action with respect to generating the map from the array of tiles, and/or other actions with respect to the array of tiles. In some implementations, method 10 may proceed from operation 30 back to operation 12 to begin method 10 again by generating another array of tiles.

Responsive to a determination at operation 28 that a suitable area exists in the first cluster, method 10 may proceed to an operation 32. At operation 32, a suitable area may be stochastically defined in the array of tiles. Defining the suitable area in the array of tiles may include assigning a secondary tile type associated with the first feature to tiles included in the suitable area. The definition of the suitable area may be stochastic in that one or more parameters of the suitable area may be stochastically determined. Such parameters may include, for example, number of tiles, size, width, length, location in the cluster, and/or other parameters. The stochastic determination of the parameters may be constrained with the criteria associated with the first feature. The stochastic determination of the parameters may include determining a parameter randomely, pseudo-randomly, and/or through other non-deterministic determinations. By way of non-limiting example, in implementations in which the first feature is a patch of dirt, the tiles in the suitable area defined at operation 28 may include assigning such tiles a secondary type that corresponds to dirt.

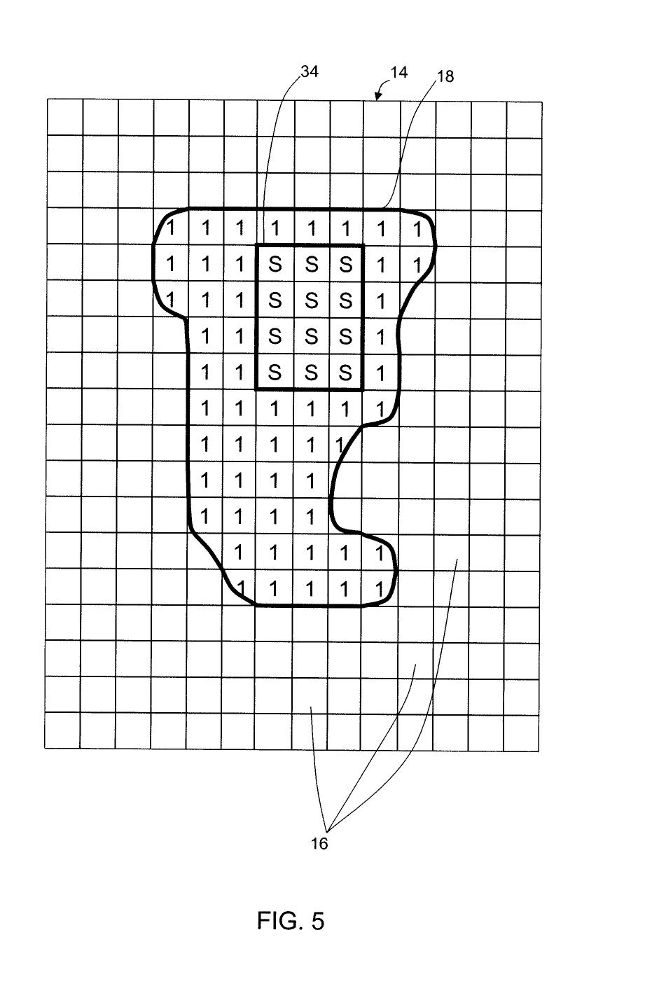

By way of illustration, FIG. 5 depicts array 14 in which a suitable area 34 has been defined within cluster 18. The assignment of tiles 16 in suitable area 34 with an appropriate secondary type may be depicted by the designation “S” on these tiles. The assignment of tiles 16 with the secondary type S may replace the previous assignment of type (e.g., first primary type), and/or may be in addition to the previous assignment.

Referring back to FIG. 1, at an operation 36, a verification may be performed as to whether the first cluster, and/or other groups of tiles in the array of tiles, meets one or more cluster criteria. The cluster criteria may include, for example, a size, a shape, a minimum and/or maximum length, a minimum and/or maximum width, and/or other criteria. Responsive to a determination at operation 36 that the first cluster, and/or other groups of tiles in the array of tiles, does not meet the cluster criteria, method 10 may proceed to operation 30 and/or back to operation 12. Responsive to a determination at operation 36 that the first cluster, and/or other groups of tiles in the array of tiles, meets cluster criteria, method 10 may proceed to an operation 38.

At operation 38, a determination may be made as to whether there are additional features to be located in the array of tiles (e.g., within the first cluster). Responsive to there being one or more additional features to be located in the array of tiles, method 10 may return to operation 28 to locate a next feature (or set of features). Some or all iterations back to operation 28 to locate additional features may not include operation 36. Responsive to there not being additional features to be located in the array tiles, method 10 may proceed to an operation 40.

At operation 40, tiles in the array of tiles may be assigned with tertiary tile types. The assignment of tertiary tile types may be on the primary or secondary types of the tiles, and/or the distributions of the primary or secondary types across the array of tiles. For a given tile, a tertiary tile type may be assigned based on a primary or secondary type of the given tile, the primary and/or secondary types of the tiles surrounding the given tile, and/or other considerations.

By way of non-limiting example, in implementations in which the first and second primary types are land and water, respectively, and the secondary types include a secondary type for dirt, the tertiary types may include grass, dirt edge, dirt interior, beach, shallow water, intermediate water, open water, and/or other types. The grass type may be assigned to first primary type tiles not assigned one of the other tertiary types. The dirt edge type may be assigned to tiles that have been previously assigned with the secondary type, and that border on one or more first primary type tiles (e.g., tiles which may be assigned the grass type). The dirt edge tiles may form a border of a patch of dirt (e.g., the first feature). The dirt interior type may be assigned to tiles that have previously been assigned with the secondary type, and that border only on other secondary type tiles. The beach type may be assigned to first primary type tiles that border on one or more second primary type tiles (e.g., a meeting of land and water). The shallow water type may be assigned to second primary type tiles that border on one or more first primary type tiles. The intermediate water type may be assigned to second primary type tiles that border on one or more shallow water type tiles. The open water type may be assigned to second primary type tiles not assigned as shallow or intermediate water types.

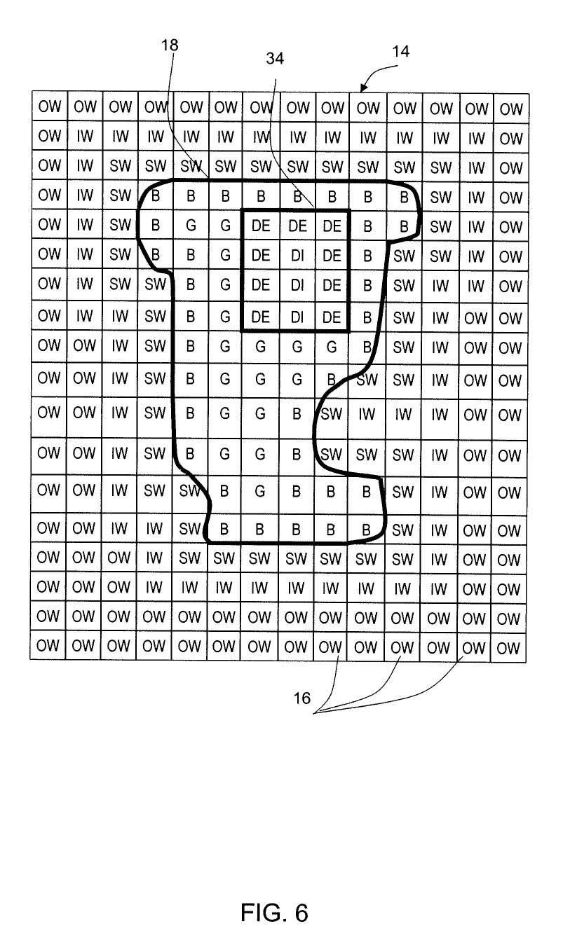

By way of illustration, FIG. 6 depicts array 14 in which tiles 16 have been assigned the tertiary types set forth above. The assignment of a grass type may be depicted with a G. The assignment of dirt edge may be depicted with a DE. The assignment of dirt interior may be depicted with a DI. The assignment of beach may be depicted with a B. The assignment of shallow water may be depicted with an SW. The assignment of intermediate water may be depicted with an IW. The assignment of open water may be depicted with an OW. It will be appreciated that the specific examples of tertiary types described particularly herein are not intended to be limiting. Rather, they have been provided purely for illustrative purposes. Other tertiary types may be implemented to generate a different type of map and/or place, including building and/or complex interiors, extra-terrestrial settings, and/or other types of maps and/or topographies.

Returning to FIG. 1, at an operation 42, one or more items may be located on the array of tiles. Such items may include, for example, a tree, a mine, a quarry, a plant, a flower, a non-player character, and/or other items. A given item may be associated with item criteria to be fulfilled by the location of the given item. Such criteria may include, for example, a tertiary type of tile on which the given item is to be placed, rules about the location of the given item relative to other items and/or features, and/or other criteria. At operation 42 if a location for the given item that conforms to the item criteria cannot be found, the given item may be placed randomly at a location that does not conform to the item criteria and/or the item may be left off of the array of tiles. Failure to identify a location for the given item that satisfies the item criteria may not result in the array of tiles being discarded. In some implementations, the number and/or type of items located at operation 42 may be predetermined, may be subject to specification by a user and/or administrator, may be determined based on one or more parameters of the array of tiles (e.g., size, shape, and/or other parameters), may be obtained via other mechanisms.

At an operation 44, tile types which may not be needed subsequently may be collapsed. For example, tertiary types intermediate water and open water may be collapsed into a single tertiary type, water. The tile types to be collapsed may include types that would not be expressed differently within a virtual space simulation of the place represented by the map.

At an operation 46, the array of tiles may be cropped. This may include dropping tiles from the edges of the array of tiles to reduce the size of the array of tiles. For example, in implementations in which the first primary type corresponds to land and the second primary type corresponds to water, operation 46 may include reducing the array to the smallest possible size in some predetermined shape (e.g., a rectangle and/or other shapes) that includes all of the items placed at operation 40, that includes all of the first cluster, that includes all of the first cluster and a buffer of at least some minimum number of tiles, and/or other portions of the array of tiles.

At an operation 48, the array of tiles may be stored for use as a map of a place in a virtual space. Method 10 may return to operation 12 to generate another map. At an operation 50, the array of tiles may be used as a map of a place in a virtual space. This may include simulating the place in the virtual space based on the array of tiles. For example, the different tile types may be represented in the virtual space with different artwork, the features and/or items located in the array of tiles may be expressed in the virtual space, and/or the place may be simulated in other ways based on the array of tiles.

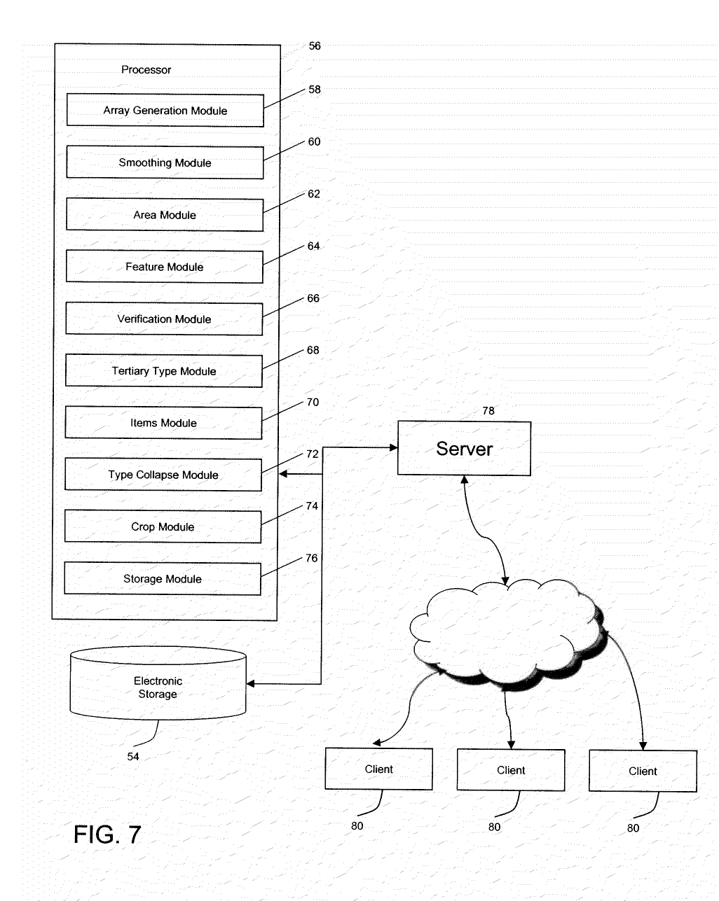

FIG. 7 illustrates a system 52 configured to generate maps of places. The maps of places may be used to simulate the places in a virtual space. The maps may be generated stochastically to provide variety in the places so that places within the virtual space may be unique (or seemingly so). In some implementations, system 52 may include electronic storage 54, one or more processors 56, and/or other components.

Processor 56 may be configured to execute computer program modules. The computer program modules may include one or more of an array generation module 58, a smoothing module 60, an area module 62, a feature module 64, a verification module 66, a tertiary type module 68, an items module 70, a type collapse module 72, a crop module 74, a storage module 76, and/or other modules.

The array generation module 58 may be configured to generate an array of tiles that form a surface. Generating the array of tiles may include assigning a primary type to the individual tiles. The primary types may include a first primary type and a secondary type. The first primary type tiles may form one or more clusters including a first cluster. The array of tiles may be generated stochastically. In some implementations, array generation module 58 may be configured to perform an operation similar to or the same as operation 12 (shown in FIG. 1 and described herein).

The smoothing module 60 may be configured to smooth bodies of tiles in the arrays of tiles generated by array generation module 58. Smoothing a body of tiles, such as a cluster, may include rounding corners, reducing or eliminating spurs, and/or other smoothing operations. In some implementations, smoothing module 60 may be configured to perform one or more operations similar to or the same as operations 20 and/or 22 (shown in FIG. 1 and described herein).

The area module 62 may be configured to determine whether suitable areas exist within clusters for placement of a feature (or features). A suitable area may be an area that satisfies one or more criteria associated with a feature. In some implementations, area module 62 may be configured to perform an operation similar to or the same as operation 28 (shown in FIG. 1 and described herein). Responsive to area module 62 determining that a given array of tiles, or a cluster within the given array of tiles, does not include a suitable area for placement of a feature, the given array of tiles may be discarded.

The feature module 64 may be configured to stochastically define suitable areas within the arrays of tiles as the features. For example, responsive to a determination by area module 62 that a suitable area exists in the given array of tiles for a feature, feature module 64 may be configured to define a suitable area in the given array of tiles as the feature. This may include defining the suitable area by assigning tiles in the suitable area with a secondary type that corresponds to the feature. In some implementations, feature module 64 may be configured to perform an operation similar to or the same as operation 32 (shown in FIG. 1 and described herein).

The verification module 66 may be configured to verify that a clusters in individual arrays of tiles satisfy criteria. Such criteria may include, for example, size, shape, minimum or maximum length, minimum or maximum width, and/or other criteria. Responsive to a determination by verification module 66 that a cluster in a given array of tiles does not meet the appropriate criteria, the given array of tiles may be discarded. In some implementations, verification module 66 may perform an operation similar to or the same as operation 36 (shown in FIG. 1 and described herein).

The tertiary type module 68 may be configured to assign tiles in the generated arrays of tiles with tertiary tile types. For a given tile, the tertiary type assigned may be a function of the primary and/or secondary type(s) of the given tile, the primary and/or secondary type(s) of tiles surrounding the given tile, and/or other parameters. In some implementations, tertiary type module 68 may be configured to perform an operation similar to or the same as 40 (shown in FIG. 1 and described herein).

The items module 70 may be configured to place items in the arrays of tiles. Items may be placed in accordance with item criteria associated with the items. Item criteria may include, for example, acceptable tertiary types for placement, spatial requirement with respect to the placement of other items and/or features, and/or other criteria. The placement of the items by items module 70 may be stochastic, within the constraints set by the item criteria. In some implementations, items module 70 may perform an operation similar to or the same as 42 (shown in FIG. 1 and described herein).

The type collapse module 72 may be configured to collapse extraneous tertiary types in the arrays of tiles. This may include collapsing two or more tertiary types into a new tertiary type, collapsing a first tertiary type into an existing second tertiary type, and/or other collapsing operations. In some implementations, type collapse module 72 may be configured to perform an operation similar to or the same as operation 44 (shown in FIG. 1 and described herein).

The crop module 74 may be configured to crop the arrays of tiles. The arrays of tiles may be cropped to remove extraneous tiles, to provide a regular shape to the arrays of tiles, and/or for other purposes. In some implementations, crop module 74 may be configured to perform an operation similar to or the same as operation 46 (shown in FIG. 1 and described herein).

The storage module 76 may be configured to manage storage of the arrays of tiles that are generated. The arrays may be stored by storage module 76, for example, to electronic storage 54, and/or to other electronic storage. In some implementations, storage module 76 may be configured to perform an operation similar to or the same as operation 48 (shown in FIG. 1 and described herein).

Electronic storage 54 may comprise electronic storage media that electronically stores information. The electronic storage media of electronic storage 54 may include one or both of system storage that is provided integrally (i.e., substantially non-removable) with processor 56 and/or removable storage that is removably connectable to processor 56 via, for example, a port (e.g., a USB port, a firewire port, etc.) or a drive (e.g., a disk drive, etc.). Electronic storage 54 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 54 may include one or more virtual storage resources (e.g., cloud storage, a virtual private network, and/or other virtual storage resources). Electronic storage 54 may store software algorithms, information determined by processor 56, information received from server 78, information received from client computing platforms 80, and/or other information that enables processor 56 to function properly.

Processor(s) 56 is configured to provide information processing capabilities in system 52. As such, processor 56 may include one or more of a digital processor, an analog processor, a digital circuit designed to process information, an analog circuit designed to process information, a state machine, and/or other mechanisms for electronically processing information. Although processor 56 is shown in FIG. 1 as a single entity, this is for illustrative purposes only. In some implementations, processor 56 may include a plurality of processing units. These processing units may be physically located within the same device, or processor 56 may represent processing functionality of a plurality of devices operating in coordination. Processor 56 may be configured to execute modules 58, 60, 62, 64, 66, 68, 70, 72, 74, and/or 76 by software; hardware; firmware; some combination of software, hardware, and/or firmware; and/or other mechanisms for configuring processing capabilities on processor 56.

It should be appreciated that although modules 58, 60, 62, 64, 66, 68, 70, 72, 74, and 76 are illustrated in FIG. 1 as being co-located within a single processing unit, in implementations in which processor xx includes multiple processing units, one or more of modules 58, 60, 62, 64, 66, 68, 70, 72, 74, and/or 76 may be located remotely from the other modules. The description of the functionality provided by the different modules 58, 60, 62, 64, 66, 68, 70, 72, 74, and/or 76 described below is for illustrative purposes, and is not intended to be limiting, as any of modules 58, 60, 62, 64, 66, 68, 70, 72, 74, and/or 76 may provide more or less functionality than is described. For example, one or more of modules 58, 60, 62, 64, 66, 68, 70, 72, 74, and/or 76 may be eliminated, and some or all of its functionality may be provided by other ones of modules 58, 60, 62, 64, 66, 68, 70, 72, 74, and/or 76. As another example, processor xx may be configured to execute one or more additional modules that may perform some or all of the functionality attributed below to one of modules 58, 60, 62, 64, 66, 68, 70, 72, 74, and/or 76.

The electronic storage 54 and/or processor 56 may be in communication with, or even associated with or included in, a server 78 configured to provide a virtual space to users via one or more client computing platforms 80. The server 78 may be configured to communicate with one or more client computing platforms 80 according to a client/server architecture. The users may access system 10 and/or the virtual [environment/space] via client computing platforms 14.

The server 78 may be configured to execute computer program modules that execute one or more instances of a virtual space in order to provide the virtual space for access by the users. The virtual space may include places represented by the maps generated by processor 56. The maps generated by processor 56 may be used by server 78 to determine the topography and/or layout of the places in the virtual space. The places in the virtual space may be expressed visually in accordance with the maps. The server 78 may be configured to communicate with processor 56 and/or electronic storage 54 to receive the maps via a network and/or a dedicated connection (e.g., including wired and/or wireless communications). In some implementations, functionality attributed herein to processor 56 and/or electronic storage 54 may be provided by one or more processors and/or electronic storage associated with server 78.

The server 78 may be configured to implement the instances of the virtual space to determine views of the virtual space. The views may then be communicated (e.g., via streaming, via object/position data, and/or other information) from server 78 to client computing platforms 80 for presentation to users. The view determined and transmitted to a given client computing platform 78 may correspond to a user character being controlled by a user via the given client computing platform 80. The view determined and transmitted to a given client computing platform 80 may correspond to a location in the virtual space (e.g., the location from which the view is taken, the location the view depicts, and/or other locations), a zoom ratio, a dimensionality of objects, a point-of-view, and/or view parameters. One or more of the view parameters may be selectable by the user. The virtual space may comprise a simulated space that has a topography or spatial layout, expresses ongoing real-time interaction by one or more users, and/or includes one or more objects positioned within the topography or layout that are capable of locomotion. In some implementations, the topography or layout may be 2-dimensional or 3-dimensional.

A given client computing platform 80 may include one or more processors configured to execute computer program modules. The computer program modules may be configured to enable an expert or user associated with the given client computing platform 80 to interface with server 78. By way of non-limiting example, the given client computing platform 80 may include one or more of a desktop computer, a laptop computer, a handheld computer, a NetBook, a Smartphone, a gaming console, and/or other computing platforms.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of generating map of a place, the method comprising:
stochastically generating an array of tiles that form a surface, wherein stochastically generating the array of tiles includes stochastically assigning a cluster of tiles with a first primary type such that the shape of the cluster of first primary type tiles is stochastic;
smoothing the shape of the cluster of first primary type tiles;
determining whether there exists within the cluster of first primary type tiles a suitable area for placement of a feature, wherein the determination is based on criteria for a suitable area;
responsive to determining that there exists within the cluster of first primary type tiles a suitable area, stochastically defining a suitable area as the feature by assigning a secondary tile type to the tiles in the defined suitable area; and
responsive to determining that no suitable area exists within the cluster of first primary type tiles, discarding the array of tiles.

2. The method of claim 1, wherein generating the array of tiles comprises assigning tiles in the array with a second primary type.

3. The method of claim 2, wherein the first primary type is land and the second primary type is water, such that the cluster of first primary type tiles forms an island in the tiles assigned the second primary type.

4. The method of claim 1, further comprising assigning the tiles in the array of tiles with tertiary tile types such that for a given tile in the array of tiles, a tertiary type is assigned based on the primary or secondary type of the tile and the primary or secondary type of the other tiles bordering the given tile.

5. The method of claim 4, wherein the tertiary types include one or more of grass, dirt, or coast.

6. The method of claim 1, wherein smoothing the shape of the cluster of first primary type tiles comprises rounding corners of the cluster and/or reducing intrusive or extrusive spurs in the shape of the cluster.

7. The method of claim 1, further comprising:
verifying that the size of the cluster of first primary type tiles meets a criteria; and
responsive to the size of the cluster of first primary type tiles not meeting the criteria, discarding the array of tiles.

8. The method of claim 1, further comprising storing the array of tiles and the assigned tile types for use as a place in a virtual space.

9. The method of claim 8, further comprising repeating the operations of the method such that a plurality of arrays of tiles and assigned tile types are stored in reserve for use in the virtual space.

10. A system configured to generating maps of places, the system comprising:
one or more processors configured to execute computer program modules, the computer program modules comprising:
an array generation module configured to stochastically generate arrays of tiles that form surfaces, wherein stochastically generating a given array of tiles includes stochastically assigning a cluster of tiles with a first primary type such that the shape of the cluster of first primary type tiles is stochastic;
a smoothing module configured to smoothing the shapes of the clusters of first primary type tiles in the generated arrays of tiles;
an area module configured to determine whether suitable areas exist within the clusters of first primary type tiles for placement of a feature, wherein such determinations are based on criteria for a suitable area; and
a feature module configured such that responsive to a determination that there exists, within the cluster of first primary type tiles in the given array of tiles, a suitable area, the feature module stochastically defines a suitable area as the feature by assigning a secondary tile type to the tiles in the defined suitable area,
wherein the computer program modules are configured such that responsive to a determination that no suitable area exists within the cluster of first primary type tiles in the given array of tiles, the given array of tiles is discarded.

11. The system of claim 10, wherein the array module is configured such that generating the given array of tiles comprises assigning tiles in the array with a second primary type.

12. The system of claim 11, wherein the first primary type is land and the second primary type is water, such that the cluster of first primary type tiles forms an island in the tiles assigned the second primary type.

13. The system of claim 10, wherein the computer program modules further comprise a tertiary type module configured to assign tiles in the generated arrays of tiles with tertiary tile types such that for a given tile in the given array of tiles, a tertiary type is assigned based on the primary or secondary type of the tile and the primary or secondary type of the other tiles bordering the given tile.

14. The system of claim 13, wherein the tertiary types include one or more of grass, dirt, or coast.

15. The system of claim 10, wherein the smoothing module is configured such that smoothing the shape of the cluster of first primary type tiles comprises rounding corners of the cluster and/or reducing intrusive or extrusive spurs in the shape of the cluster.

16. The system of claim 10, wherein the computer program modules further comprise a verification module configured to verify that the sizes of the clusters of first primary type tiles in the generated arrays of tiles meets a criteria, wherein the computer program modules are configured such that responsive to the size of the cluster of first primary type tiles in the given array of tiles not meeting the criteria, the given array of tiles is discarded.

17. The method of claim 1, further comprising a storage module configured to store the arrays of tiles and the assigned tile types for use as places in a virtual space.

18. A non-transient computer readable storage medium having stored thereon computer-readable instructions configured to cause one or more processors to execute a method of generating a map of a place, the method comprising:
stochastically generating an array of tiles that form a surface, wherein stochastically generating the array of tiles includes stochastically assigning a cluster of tiles with a first primary type such that the shape of the cluster of first primary type tiles is stochastic;
smoothing the shape of the cluster of first primary type tiles;
determining whether there exists within the cluster of first primary type tiles a suitable area for placement of a feature, wherein the determination is based on criteria for a suitable area;
responsive to determining that there exists within the cluster of first primary type tiles two or more suitable areas, stochastically defining a suitable area as the feature by assigning a secondary tile type to the tiles in the suitable area; and
responsive to determining that no suitable area exists within the cluster of first primary type tiles, discarding the array of tiles.
